(19) United States
(12) Patent Application Publication
(10) Pub. No.: US 2023/0164389 A1
(43) Pub. Date: May 25, 2023

(54) Analyzing Content Of A Media Presentation

(71) Applicant: QUALCOMM Incorporated, San Diego, CA (US)

(72) Inventors: Danlu ZHANG, San Diego, CA (US); Christopher LOTT, San Diego, CA (US); Patrick HUGHES, Carlsbad, CA (US); Jiaying PAN, Rancho Santa Fe, CA (US); Giridhar Dhati Mandyam, San Diego, CA (US)

(21) Appl. No.: 17/455,848

(22) Filed: Nov. 19, 2021

(51) Int. Cl. H04N 21/454; H04N 21/466; H04N 21/24

(52) U.S. Cl. CPC H04N 21/4542; H04N 21/4662; H04N 21/2407

(57) ABSTRACT

Embodiments include systems and methods for analyzing content of a media presentation within a receiving computing device. In embodiments, a processor of a computing device may analyze media data within a media bitstream while receiving, such as prior to or in parallel with presentation of, the media data to determine whether the media data includes objectionable content. The processor may modify a presentation of the media data in response to determining that the analyzed media data includes objectionable content. The computing device may be a wireless communication device.

### BACKGROUND

Parental controls are a feature often included in electronic devices and software that enable access control to certain content. Most often, parental controls are intended to enable controlling access to content from the Internet and other similar networks. However, parental control features are notoriously ineffective. For example, common parental control tools are often defeated by using a virtual private network (VPN), because parental control tools typically rely on an analysis of a network source (e.g., a domain name or internet protocol (IP) address) or network connection, which are obfuscated or made unavailable by a VPN.

### SUMMARY

Various aspects include systems and methods for analyzing content of a media presentation and modifying presentation of the media content if appropriate that may be performed by a processing device of a computing device. Various aspects may include analyzing, in the computing device, media data within a media bitstream while receiving, such as prior to or in parallel with presentation of, the media data to determine whether the media data includes objectionable content, and modifying a presentation of the media data by the computing device in response to determining that the analyzed media data includes objectionable content.

In some aspects, analyzing media data within a media bitstream while receiving the media data may include: processing the media data using a machine learning model trained to recognize certain objectionable content, and receiving a determination of whether the media data includes objectionable content as an output from the trained machine learning model.

Some aspects may further include comprising storing a sample of the media data in a memory separate from a presentation pipeline for presenting the media data as the media data is received by the presentation pipeline, in which analyzing media data within a media bitstream while receiving the media data may include analyzing the sample of the media data stored in the separate memory. In some aspects, storing the sample of the media bitstream in a memory separate from the presentation pipeline for presenting the media data may include copying one or more portions of a frame of the media data in the media bitstream to the memory.

In some aspects, analyzing media data within a media bitstream while receiving the media data may include selecting portions of the media bitstream at random intervals, and analyzing each selected portion of the media bitstream to determine whether the selected portion of the media bitstream includes objectionable content. In some aspects, analyzing media data within a media bitstream while receiving the media data may include selecting portions of the media bitstream at a time interval, analyzing each selected portion of the media bitstream to determine whether the selected portion of the media bitstream includes objectionable content, and decreasing the time interval for selecting portions of the media bitstream in response to determining that the analyzed selected portion of the media bitstream includes objectionable content. In some aspects, the time interval may include an initial time interval that is longer than a frame rate of the media bitstream.

In some aspects, analyzing media data within a media bitstream while receiving the media data to determine whether the media data may include objectionable content may include analyzing image data of the media data at an initial resolution, and the method further may include analyzing the image data at a higher resolution in response to determining that the media data analyzed at the initial resolution may include objectionable content.

In some aspects, analyzing media data within a media bitstream while receiving, such as prior to or in parallel with presentation of, the media data to determine whether the media data may include objectionable content may include determining a type of the objectionable content, and modifying a presentation of the media data in response to determining that the analyzed media data may include objectionable content may include modifying the presentation of the media data based on the determined type of the objectionable content.

In some aspects, analyzing media data within a media bitstream while receiving the media data to determine whether the media data may include objectionable content may include identifying a specific portion of the media data that may include the objectionable content, and modifying a presentation of the media data in response to determining that the analyzed media data may include objectionable content may include limiting the modifying of the presentation of the media data to the identified specific portion of the media data.

In some aspects, modifying presentation of the media data may include modifying presentation of the media data to prevent or minimize perceptible presentation of the objectionable content. In some aspects, modifying presentation of the media data may include modifying presentation of the media data to presenting a critical thinking warning within a presentation of the media data.

Further aspects may include a computing device, such as a wireless communication device, including a memory and a processing device coupled to the memory and configured with processor-executable instructions to perform operations of any of the methods described above. Further aspects may include a computing device including means for performing functions of any of the methods described above. Further aspects may include processor-readable storage media upon which are stored processor executable instructions configured to cause a processor of a computing device to perform operations of any of the methods described above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of some embodiments.

FIG. 1 is a component block diagram illustrating a computing device suitable for implementing any of the various embodiments.

FIG. 2 is a component block diagram illustrating a computing device suitable for implementing any of the various embodiments.

FIG. 3 is a component block diagram illustrating an example computing system suitable for implementing any of the various embodiments.

FIG. 4 is a component block diagram illustrating aspects of a computing device configured to analyze content of a media presentation in accordance with various embodiments.

FIG. 5 is a process flow diagram illustrating a method for analyzing content of a media presentation in accordance with various embodiments.

FIG. 6 is a process flow diagram illustrating operations that may be performed as part of the method for analyzing content of a media presentation in accordance with various embodiments.

FIG. 7 is a process flow diagram illustrating operations that may be performed as part of the method for analyzing content of a media presentation in accordance with various embodiments.

FIG. 8 is a process flow diagram illustrating operations that may be performed as part of the method for analyzing content of a media presentation in accordance with various embodiments.

FIG. 9 is a process flow diagram illustrating operations that may be performed as part of the method for analyzing content of a media presentation in accordance with various embodiments.

FIG. 10 is a process flow diagram illustrating operations that may be performed as part of the method for analyzing content of a media presentation in accordance with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of various embodiments or the claims.

Various embodiments enable content analysis and filtering by an endpoint computing device that receives and renders audio and visual content (referred to herein as “media data”). In various embodiments, just prior to or in parallel with producing an audio and/or video presentation of the media data (e.g., by an output device such as a display device or a speaker), the computing device may analyze media data within a presentation pipeline to determine whether the media data includes objectionable content. In some embodiments, the computing device may perform the content filtering on media data that is copied from a memory in the media presentation pipeline, such as in a display buffer or audio buffer, and stored in a separate memory for analysis, prior to the media data being sent from the display buffer or audio buffer to an output device (e.g., a display or speaker). In response to determining that the analyzed media data includes objectionable content, the processor may modify a presentation of the media data, such as to prevent or limit perception of the objectionable content.

The term “presentation” with respect to media data is used herein to refer generally to the perceptible rendering of sounds and/or images encompassed within the media data. For example, presentation of media data may encompass the generation of sound (i.e., an audio output) and the display of images (i.e., a display output) of a video stream. Similarly, the term “presenting media data” is used herein generally to refer to the processes of generating the perceptible rendering of sounds and/or images encompassed within the media data.

The term “computing device” is used herein to refer to any one or all of cellular telephones, smartphones, head-mounted devices, smart glasses, extended reality (XR) devices, augmented reality (AR) devices, portable computing devices, personal or mobile multi-media players, laptop computers, tablet computers, smartbooks, ultrabooks, palmtop computers, electronic mail receivers, multimedia Internet-enabled cellular telephones, router devices, medical devices and equipment, biometric sensors/devices, wearable devices including smart watches, smart clothing, smart glasses, smart wrist bands, smart jewelry (e.g., smart rings, smart bracelets, etc.), entertainment devices (e.g., gaming controllers, music and video players, satellite radios, etc.), Internet of Things (IoT) devices including smart meters/sensors, industrial manufacturing equipment, large and small machinery and appliances for home or enterprise use, computing devices within autonomous and semiautonomous vehicles, mobile devices affixed to or incorporated into various mobile platforms, global positioning system devices, and similar electronic devices that include a memory and a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement Global System for Mobile communication (GSM) Enhanced Data rates for GSM Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use Long Term Evolution (LTE) standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems may be discussed herein, those systems are referenced merely as examples and future generation systems (e.g., sixth generation (6G) or higher systems) may be substituted in the various examples.

The terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

As used herein, the term “objectionable content” refers to content that some observers or parents of minors would find objectionable, including but not limited to scenes of violence or oppression, content of a pornographic or prurient nature, content including images or language that attacks a person or people based on race, color, religion, ethnic group, gender, or sexual orientation, content about a controversial or divisive topic (e.g., an emotionally charged political, social, or religious topic), foul or objectionable language, misinformation, disinformation, and propaganda (e.g., content intended to sway opinion, inspire action, or to promote or oppose a particular view or position).

Parental control features implemented on personal computing devices for presenting Internet content are often ineffective at properly filtering objectionable content due to limitations in the way such control features work. Conventional parental control features typically rely on blocking content from a particular source known to present objectionable content, such as a network source (e.g., a domain name, an internet protocol (IP) address or range of IP addresses, etc.). Thus, common parental control tools may be defeated by VPNs and other systems that obfuscate, hide, or alter the source of content.

Various embodiments include performing media content analysis by an endpoint computing device that receives and presents media data. Various embodiments operate on the media data on the computing device, rather than attempting to filter or block certain content based on its network source. In some embodiments, the computing device may receive media data from a content sender (e.g., via a communication network), and may process the media data to prepare it for presentation by the computing device. In various embodiments, just prior to, or in parallel with, processing the media data for presentation, the computing device may analyze media data within the media bitstream to determine whether the media data includes objectionable content. In various embodiments, the analysis by the endpoint computing device may be performed on the raw content and not depend on rating metadata encoded in the media data. In some embodiments, the analysis may be applied to the media data after decoding or decompression. Pattern recognition techniques may be applied to the data ready for video display or audio play to identify objectionable content. Additional processing may include re-encoding (or compressing) the media data and applying metadata extraction on the compressed data to identify objectionable content. Analysis of meta-data may supplement these analyses. In some embodiments, the content analysis by the endpoint computing device may be performed by a processor of the computing device executing operating instructions (e.g., software) implementing various embodiments and stored in non-transitory processor-readable media. In some embodiments, the content analysis by the endpoint computing device may be performed by dedicated hardware (e.g., dedicated circuitry, a dedicated processor configured by firmware, etc.) within the computing device. In some embodiments, the content analysis by the endpoint computing device may be performed by a combination of a processor executing operating instructions and dedicated hardware. To address these alternative configurations for performing embodiment methods, a processor and/or dedicated hardware may be referred to generally as a “processing device.”

In some embodiments, the computing device may process the media data using a machine learning model that has been trained to recognize certain objectionable content in the media data and provide as an output a determination of whether the media data includes objectionable content. Certain characteristic images or sound may be used as patterns to be searched for in the media data. Such pattern recognition methods may involve transforming certain parts of the media data by operations such as shift, rotation, zoom-in or out, etc., and applying neural network based artificial intelligence (AI) methods for pattern matching. Convolutional neural networks (CNN) may be a suitable neural network architecture for machine learning models used to process image and/or video data. The transformation may be viewed as pre-processing for the neural network operations. The computing device may receive as output from the trained machine learning model a determination of whether the media data includes objectionable content, as well as an indication of the type of objectionable content in some embodiments. The output could also include the degrees of confidence on the content detection or degree of similarity between the data and the targeted content. Detection may be determined or alarms may be set if such confidence is higher than a threshold. The detection result may be presented to the end user or other humans for further determination. Machine learning models may adapt the algorithms including such thresholds based on the human inputs.

In some embodiments, the computing device may store a sample of the media data in a memory separate from a presentation pipeline for presenting the media data. In some embodiments, the computing device may copy media data from a memory in the media presentation pipeline, such as a display buffer or audio buffer, and may store the copied media data for analysis in a separate memory that used for holding (e.g., buffering) media data for purposes of analyzing the media data. The data for further analysis may be in digital form, but preferably such data may be obtained in the pipeline close to the step in which the data is converted to analogue signals for presentation. Such data may be closest to the final form that are being viewed or listened to by the end user but still in the digital domain. In some embodiments, the computing device may analyze media data stored in the separate memory prior to the media data being sent from the display buffer or audio buffer to an output device or a presentation device (e.g., a display device, a speaker, etc.). In some embodiments, the computing device may analyze the sample of the media data stored in the separate memory to determine whether the sample of the media data includes objectionable content. For example, in operation, the computing device may transfer media data from the display buffer or audio buffer to an output device or a presentation device. In some embodiments, while receiving, such as prior to or in parallel with presentation of, the media data, the computing device may copy some of the media data and store the copied media data in another memory location that is not included in the presentation pipeline for the media data and analyze the portion of the media data stored in the other memory location for objectionable content. In some embodiments, the computing device may copy one or portions of a frame of the media data in the media bitstream. In various embodiments, the frame may be a video frame, an image frame, an audio frame, or another suitable frame or other portion of the media data.

In some embodiments, the computing device may select portions of the media bitstream over time. In some embodiments, the computing device may select portions of the media bitstream at a time interval. In some embodiments, the computing device may select (and copy) portions of the media bitstream at an interval that is longer than (i.e., less frequent than) a frame rate of the media bitstream. In some embodiments, the computing device may select the portion(s) of the media bitstream randomly to minimize opportunities for circumventing analysis and modification of media streams. In some embodiments, the computing device may dynamically adjust the frequency at which portions of the media bitstream are selected for analysis. For example, the computing device may select portion(s) of the media bitstream at an initial time interval (e.g., a time interval greater than a frame rate of the media bitstream). In some embodiments, in response to determining that the analyzed media data includes objectionable content, the computing device may decrease the time interval for selecting the portions of the media bitstream.

In some embodiments, the computing device may dynamically adjust a level of scrutiny applied to the media data. For example, in some embodiments, the computing device may analyze image data at an initial image or sound resolution, such as images relatively low pixel density resolution. For example, instead of analyzing full resolution images in the media data, the processing device (i.e., processor and/or custom circuitry) may sample a portion of images or sample a certain fraction of pixels within the images, and analyze the sampled portions or pixels to detect objectionable content. As another example, instead of analyzing audio data as presented in the media data stream, the processing device (i.e., processor and/or custom circuitry) may sample brief snippets of the audio or sample a reduced range of frequencies to detect objectionable content. Analyzing image and/or audio data at a relatively low resolution may decrease the computational burden on a processing device (i.e., a processor and/or custom circuitry) consumption of the computing device. In response to determining that the media data analyzed at the initial resolution includes objectionable content, the computing device may analyze the image and or audio data at a higher resolution than the initial resolution, such as the full images and/or all pixels in images and/or the full audio data stream.

Various embodiments include content filtering of media data based on the analysis of the content by the endpoint computing device that receives and presents the media data. In response to determining that the analyzed media data includes objectionable content, the processor may modify a presentation of the media data. In some embodiments, the computing device may modify the presentation of the media data by preventing or minimizing a perceptible presentation of the objectionable content. Operations to prevent or minimize a perceptible presentation of the objectionable content may include blurring or fuzzing an image or a portion of an image, blocking or preventing the presentation of an image or a portion of an image, “bleeping” or reducing the volume of objectionable audio content, and other suitable operations to prevent or minimize a perceptible presentation of the objectionable content.

In some embodiments, the computing device may present a “critical thinking” warning within a presentation of the media data. For example, the computing device may determine that the analyzed media data includes bad words or foul language. As another example, the computing device may determine that the analyzed media data includes content about a controversial political, social, or religious topic. In response to determining that the analyzed media data includes such objectionable content, the computing device may present (e.g., visually, audibly, etc.) an indication that the content may be of a controversial or potentially offensive nature. In some embodiments, the computing device may present an indication that the user consuming the content (e.g., watching, listening, etc.) should consider critically the language used or situations portrayed in the content, or be skeptical of claims made in the content, or should fact-check claims made in the content, and/or the like. In this manner, various embodiments may identify content that may be objectionable, or may identify propaganda, misinformation, “fake news,” and other similar content, and may present a critical thinking warning within a presentation of the media data without censoring the content.

In some embodiments, the computing device may store the media stream to memory while the analysis of the media data is performed, followed by presenting the media data from memory with filtering or modification performed on the stored media data in response to the analysis. In some embodiments, the computing device may determine a time and/or a type of the objectionable content contained in the media data, and modify the presentation of the media data based on the determined type and time of the objectionable content. In some embodiments, the computing device may identify the objectionable content in a specific portion, location, time period, or another specific portion of the media data. In some embodiments, the computing device may limit modifying the presentation of the media data to the specific portion of the media data in which the objectionable content has been identified.

Various embodiments improve the operation of computing devices configured to analyze content of a media presentation by enabling the computing device to perform content filtering based on an analysis of the content of the media presentation. Various embodiments improve the performance of content filtering operations by enabling computing device to analyze content of a media presentation outside of a presentation pipeline for presenting the media data, thereby avoiding an added computational burden to the presentation pipeline. Various embodiments improve the performance of content filtering operations by enabling computing device to recognize objectionable material in media data that does not include rating or audience suitability metadata. Various embodiments improve the performance of content filtering operations by enabling computing device to recognize objectionable material in media in a manner that is difficult to circumvent by the media provider and/or a user of the computing device.

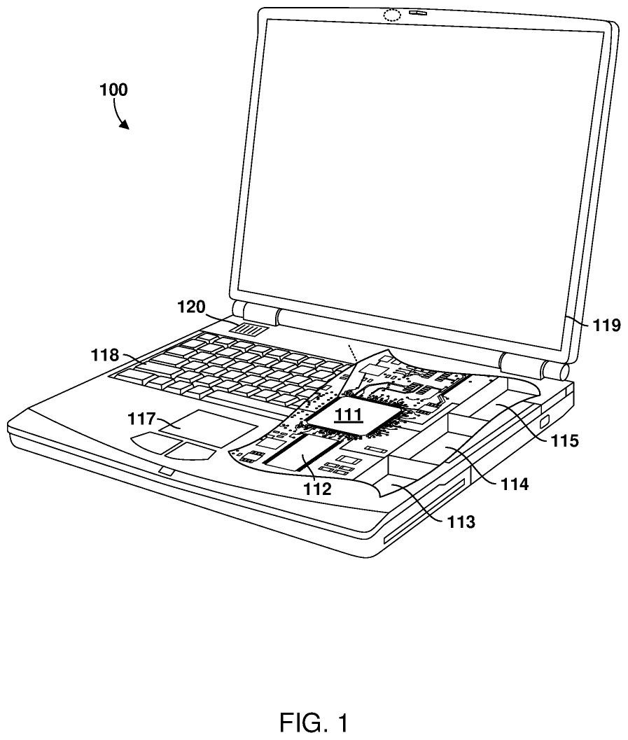

FIG. 1 is a component block diagram illustrating a computing device 100 suitable for implementing any of the various embodiments. Various embodiments may be implemented within a variety of computing devices, an example of which is illustrated in FIG. 1 as a laptop computer. The computing device 100 may include a processor 111 coupled to volatile memory 112 and a large capacity nonvolatile memory, such as a disk drive 113 of Flash memory. In some embodiments, the processor 111 may include one or more System-On-Chip (SOC) processors (such as an SOC-CPU). The computing device 100 may include a display device 119 coupled to the processor 111 and suitable for presenting media data. The computing device 100 may include an audio device 120, such as a speaker, coupled to the processor 111 and suitable for presenting audio media data. The computing device 100 may include a touchpad touch surface 117 that serves as the computer's pointing device, and which may receive inputs to operate various aspects of the computing device 100. The computing device 100 also may include a floppy disc drive 114 and a compact disc (CD) drive 115 coupled to the processor 111. The computing device 100 also may include a number of connector ports coupled to the processor 111 for establishing data connections or receiving external memory devices, such as a universal serial bus (USB) or FireWire® connector sockets, or other network connection circuits for coupling the processor 111 to a network. A housing of the computing device 100 may include the touchpad 117, the keyboard 118, the display 119, and the audio device 120, each operatively coupled to the processor 111.

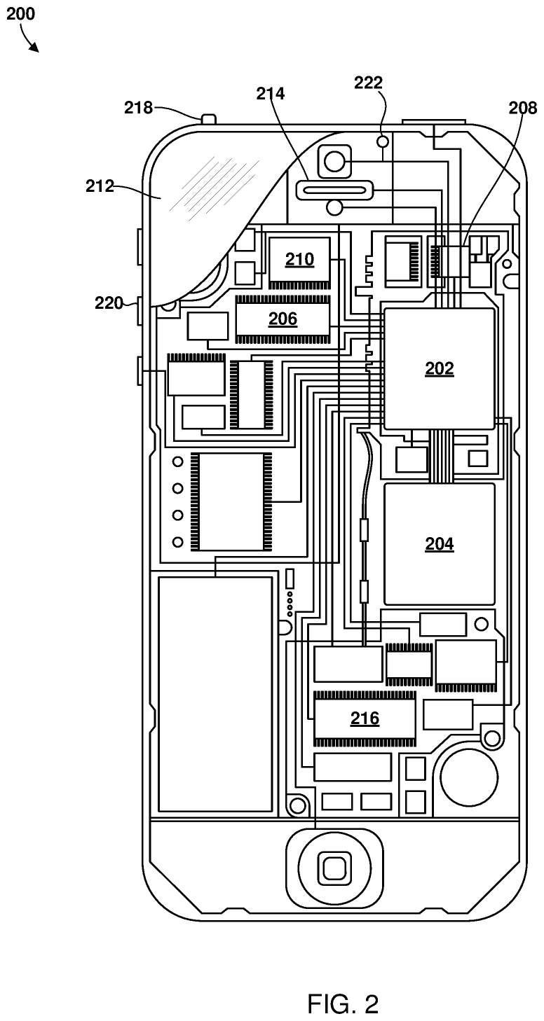

FIG. 2 is a component block diagram of an example computing device 200 in the form of a wireless communication device suitable for implementing any of the various embodiments. With reference to FIGS. 1 and 2, the computing device 200 may include a first SOC processor 202 (such as an SOC-CPU) coupled to a second SOC 204 (such as a Fifth Generation New Radio (5G NR) capable SOC). The first and second SOCs 202, 204 may be coupled to internal memory 206, 216, a display 212, and to a speaker 214. Additionally, the computing device 200 may include an antenna 218 for sending and receiving electromagnetic radiation that may be connected to a wireless data link and/or wireless transceiver 208 coupled to one or more processors in the first and/or second SOCs 202, 204. The one or more processors may be configured to determine signal strength levels of signals received by the antenna 218. The computing device 200 may also include menu selection buttons or rocker switches 220 for receiving user inputs. In addition, soft virtual buttons may be presented on display 212 for receiving user inputs.

The computing device 200 may also include a sound encoding/decoding (CODEC) circuit 210, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 208 and CODEC 210 may include a digital signal processor (DSP) circuit (not shown separately). The computing device 200 may also include one or more optical sensors 222, such as a camera. The optical sensors 222 may be coupled to one or more processors in the first and/or second SOCs 202, 204 to control operation of and to receive information from the optical sensor(s) 222 (e.g., images, video, and the like).

The processors (e.g., SOCs 202, 204) of the computing device 200 may be any programmable microprocessor, microcomputer or multiple processor chip or chips that can be configured by software instructions (applications) to perform a variety of functions, including the functions of the various embodiments described below. In some wireless devices, multiple processors may be provided, such as one processor within an SOC 204 dedicated to wireless communication functions and one processor within an SOC 202 dedicated to running other applications. Typically, software applications including processor-executable instructions may be stored in non-transitory processor-readable storage media, such as the memory 206, 216, before the processor-executable instructions are accessed and loaded into the processor. The processors 202, 204 may include internal memory sufficient to store the application software instructions. The mobile device 200 may also include optical sensors such as a camera (not shown).

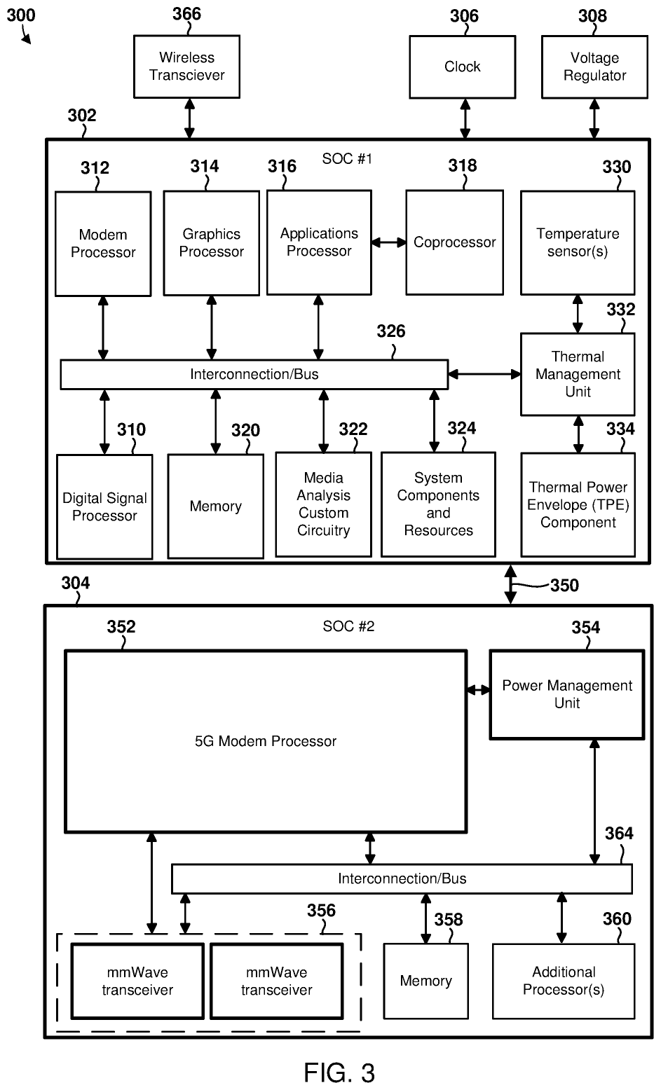

FIG. 3 is a component block diagram illustrating an example computing system 300 suitable for implementing any of the various embodiments. Various embodiments may be implemented on a number of single processor and multiprocessor computer systems, including a SOC or system in a package (SIP).

With reference to FIGS. 1-3, the illustrated example computing system 300 may include two SOCs 302, 304, a clock 306, a voltage regulator 308, and a wireless transceiver 366 configured to send and receive wireless communications via an antenna (not shown). In some embodiments, the first SOC 302 may operate as central processing unit (CPU) of the wireless device that carries out the instructions of software application programs by performing the arithmetic, logical, control and input/output (I/O) operations specified by the instructions. In some embodiments, the second SOC 304 may operate as a specialized processing unit. For example, the second SOC 304 may operate as a specialized 5G processing unit responsible for managing high volume, high speed (e.g., 5 Gbps, etc.), and/or very high frequency short wave length (e.g., 28 GHz millimeter wave (mmWave) spectrum, etc.) communications.

The first SOC 302 may include a digital signal processor (DSP) 310, a modem processor 312, a graphics processor 314, an application processor 316, one or more coprocessors 318 (e.g., vector co-processor) connected to one or more of the processors, memory 320, custom circuity 322, system components and resources 324, an interconnection/bus module 326, one or more temperature sensors 330, a thermal management unit 332, and a thermal power envelope (TPE) component 334. The second SOC 304 may include a 5G modem processor 352, a power management unit 354, an interconnection/bus module 364, a plurality of mmWave transceivers 356, memory 358, and various additional processors 360, such as an applications processor, packet processor, etc.

Each processor 310, 312, 314, 316, 318, 352, 360 may include one or more cores, and each processor/core may perform operations independent of the other processors/cores. For example, the first SOC 302 may include a processor that executes a first type of operating system (e.g., FreeBSD®, LINUX FreeBSD, macOS®, etc.) and a processor that executes a second type of operating system (e.g., MICROSOFT® WINDOWS 10). In addition, any or all of the processors 310, 312, 314, 316, 318, 352, 360 may be included as part of a processor cluster architecture (e.g., a synchronous processor cluster architecture, an asynchronous or heterogeneous processor cluster architecture, etc.).

The first and second SOC 302, 304 may include various system components, resources and custom circuitry for managing sensor data, analog-to-digital conversions, wireless data transmissions, and for performing other specialized operations, such as decoding data packets and processing encoded audio and video signals for audio and/or visual presentation in a web browser. For example, the system components and resources 324 of the first SOC 302 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 324 and/or custom circuitry 322 may also include circuitry to interface with peripheral devices, such as cameras, electronic displays, wireless communication devices, external memory chips, etc.

The first and second SOC 302, 304 may communicate via interconnection/bus module 350. The various processors 310, 312, 314, 316, 318, may be interconnected to one or more memory elements 320, system components and resources 324, and a thermal management unit 332 via an interconnection/bus module 326. Similarly, the processor 352 may be interconnected to the power management unit 354, the mmWave transceivers 356, memory 358, and various additional processors 360 via the interconnection/bus module 364. The interconnection/bus module 326, 350, 364 may include an array of reconfigurable logic gates and/or implement a bus architecture (e.g., CoreConnect®, AMBA, etc.). Communications may be provided by advanced interconnects, such as high-performance networks-on chip (NoCs).

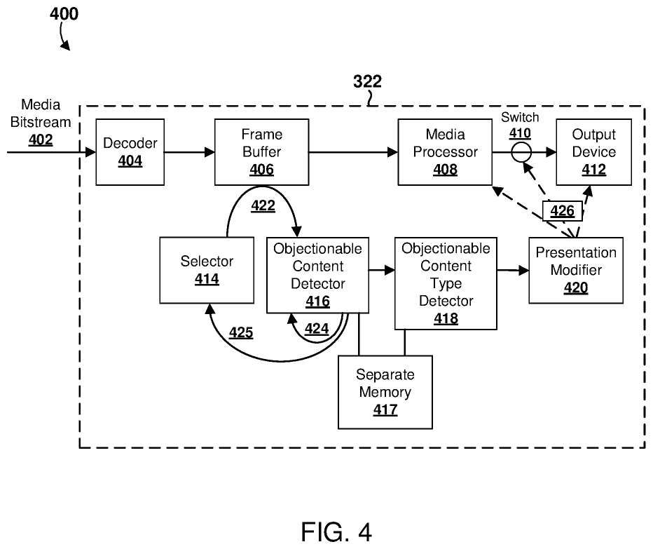

Some embodiments may be implemented in hardware, such as media analysis custom circuitry 322 that includes logic modules illustrated in FIG. 4 configured (e.g., with firmware) to perform operations of various embodiments as described herein. Media analysis custom circuitry 322 including the logic modules illustrated in FIG. 4 is referred to herein as a processing device.

The first and/or second SOCs 302, 304 may further include an input/output module (not illustrated) for communicating with resources external to the SOC, such as a clock 306 and a voltage regulator 308. Resources external to the SOC (e.g., clock 306, voltage regulator 308) may be shared by two or more of the internal SOC processors/cores.

In addition to the example SIP 300 discussed above, various embodiments may be implemented in a wide variety of computing systems, which may include a single processor, multiple processors, multicore processors, or any combination thereof.

FIG. 4 is a logic component block diagram illustrating operational modules of a processing device configured to analyze content of a media presentation in accordance with various embodiments. With reference to FIGS. 1-4, in various embodiments, the method may include various functions, modules, and/or blocks that may be implemented in software executing in a processor (e.g., 111, 202, 204) of a computing device (e.g., 100, 200), hardware (e.g., media analysis custom circuitry 322), or a combination of hardware and software, collectively referred to herein as a processing device.

The computing device 400 may include a presentation pipeline for rendering the media data including a decoder 404, a frame buffer 406, a media processor 408, a switch 410, and an output device 412. The decoder 404 may receive a media bitstream 402, for example, from a source such as a communication network (not illustrated). The media bitstream 402 may include information representing an image or images, video, audio, multimedia, and/or other suitable media data. The decoder 404 may perform decoding operations on the media bitstream 402 and provide portions of the decoded media bitstream, such as frames, to the frame buffer 406. The frame buffer 406 may perform an ordering process to place the received portions of the decoded media bitstream into a sequence. The frame buffer 406 may send the sequence of media bitstream portions to the media processor 408 (e.g., a display processing unit, a graphics processing unit 314 (GPU), an audio processor, etc.). The media processor 408 may prepare the sequence of media bitstream portions for output and may send the sequence of media bitstream portions to the output device 412 (e.g., the display device 119, 212, the speaker 120, 214, and or the like) via the switch 410.

The computing device 400 also may include blocks, modules, and/or functions for analyzing content of a media presentation, including a selector 414, an objectionable content detector 416, a separate memory 417 (i.e., a memory separate from memory (e.g., 406) used in the presentation pipeline, an objectionable content type detector 418, and a presentation modifier 420. The selector 414, objectionable content detector 416, objectionable content type detector 418, and presentation modifier 420 may operate separately from, and in some embodiments parallel to, the media presentation pipeline. In some embodiments, the selector 414 may receive decoded media data output by the decoder 404, such as directly from the decoder or by tapping into the output provided to the frame buffer 406. In some embodiments, the selector 414 may access and select decoded media data from the frame buffer 406. In some embodiments, in operation 422, the selector 414 may select a portion of the media bitstream 402 (e.g., a sample of the media bitstream 402), for example, that has been stored in the frame buffer 406, and provide the selected portion of the media bitstream 402 to the objectionable content detector 416. In some embodiments, the selector 414 may select the portion of the media bitstream 402 at random. In some embodiments, the selector 414 may copy the selected portion of the media bitstream to a memory location, such as the separate memory 417 separate from a memory location used by the media presentation pipeline, such as separate from the frame buffer 406. In this manner, the operations of analyzing content of the media presentation may be performed by a processing device (e.g., a processor and/or custom circuitry in the objectionable content detector 416) using separate memory 417, and thus place no additional computational burden on the media presentation pipeline. In some embodiments, the selector 414 may copy one or more portions of the frame of media data in the media bitstream. In some embodiments, the selector 414 may select and/or copy the portions of the media bitstream at a time interval. In some embodiments, the time interval may be longer than a frame rate (e.g., an audio frame rate, a video frame rate, etc.) of the media bitstream 402.

The objectionable content detector 416 may analyze or process media data within the media bitstream to determine whether the media data includes objectionable content. In some embodiments, the objectionable content detector 416 may include a machine learning model that has been trained to process media data to recognize certain objectionable content. In some embodiments, the objectionable content detector 416 may receive as an output from the trained machine learning model a determination of whether the media data includes objectionable content. In some embodiments, the objectionable content detector 416 may analyze the portion of the media bitstream 402 (e.g., the sample of the media bitstream 402) that is stored in the memory separate from memory used by the media presentation pipeline. In various embodiments, objectionable content detector 416 may analyze any aspect of the media data, including text (e.g., closed captions, chyron text, headlines, titles, subtitles, banners, signs, placards, and/or the like), images (e.g., faces, body parts, objects such as weapons, images such as fire or explosions, actions or image sequences that include violence or gore, and/or the like), sounds (e.g., sound effects, speech or other human sounds, words, phrases, and/or the like), and/or any other aspect of the media data.

In some embodiments, the objectionable content detector 416 may identify objectionable content in a specific portion, location, time period, or another specific aspect of the media data. For example, the objectionable content detector 416 may identify a portion of an image frame or video frame as including the objectionable content. As another example, the objectionable content detector 416 may identify a specific timestamp or time range as including the objectionable content. In various embodiments, the objectionable content detector 416 may send an indication of the specific portion, location, time period, or other specific aspect of the media data that includes the objectionable content to the presentation modifier 420 via the objectionable content type detector 418.

In embodiments in which the objectionable content detector 416 includes a machine learning model, the machine learning model may be configured and trained to process media data by receiving the media data as an input to the model and providing an output that indicates whether the media data includes objectionable content. In some embodiments, the machine learning model may be trained and configured to output an indication of the type of objectionable content recognized in the media data. In some embodiments, the machine learning model may be trained to recognize pornographic or prurient images, video, or audio content. In some embodiments, the machine learning model may be trained to recognize images, video, or audio content (e.g., words or phrases) that attack a person or people based on race, color, religion, ethnic group, gender, or sexual orientation. In some embodiments, the machine learning model may be trained to recognize images, video, or audio content about a controversial or divisive topic. In some embodiments, the machine learning model may be trained to recognize images, video, or audio media content that includes foul language. In some embodiments, the machine learning model may be trained to recognize images, video, or audio content that includes misinformation, disinformation, or propaganda. In some embodiments, the machine learning model may be updated from time to time, for example, to reflect changes in what may be considered controversial or misinformation. For example, the machine learning model may be updated to identify misinformation about a new disease. As another example, the machine learning model may be updated to identify a newly controversial topic or content, such as identifying the word or phrases that include the word “vaccine” where vaccines previously had not been considered controversial. Other examples may include sensitive social, political, religious, economic, or other content.

In some embodiments, the objectionable content detector 416 may analyze image data of the media data at an initial resolution. In response to determining that the media data analyzed at the initial resolution includes objectionable content, in operation 424, the objectionable content detector 416 may analyze the image data at a higher resolution. In this manner, the objectionable content detector 416 may, in some embodiments, conserve processing resources by performing an initial analysis at a relatively low resolution, and then in response to making an initial determination of that the media data includes objectionable content, increase a level of scrutiny of the media data by analyzing the image data at a higher resolution.

In operation 425, the objectionable content detector 416 may adjust the time interval at which the selector 414 selects and/or copies portions of the media bitstream. For example, the selector 414 may select the portions of the media bitstream at an initial time interval. In response to determining that the analyzed media data includes objectionable content, the objectionable content detector 416 may send an indication or instruction in operation 425 to adjust the time interval at which the selector 414 selects and/or copies portions of the media bitstream to a separate memory 417 (e.g., a buffer memory separate from a frame buffer 406 in the presentation pipeline) for analysis. In some embodiments, in response to determining that the analyzed media data includes objectionable content, the objectionable content detector 416 may send an indication or instruction in operation 425 to decrease the time interval for selecting portions of the media bitstream for analysis. In response to the instruction or indication to decrease the time interval, the selector 414 may select and/or copy the portions of the media bitstream for analysis more frequently (i.e., using a smaller time interval).

In some embodiments, the objectionable content detector 416 may send an indication that the media data includes objectionable content to the objectionable content type detector 418. The objectionable content type detector 418 may determine a type of the objectionable content. For example, the objectionable content type detector 418 may identify the type of objectionable content as pornography or sexual content, foul language, misinformation, disinformation, propaganda, and/or the like. As another example, the objectionable content type detector 418 may identify the type of objectionable content as not suitable for children under a specified age. In various embodiments, the objectionable content type detector 418 may send an indication of the determined type of the objectionable content to the presentation modifier 420.

In some embodiments, in operation 426, the presentation modifier 420 may modify a presentation of the media data in response to the determination that the analyzed media data includes objectionable content. In some embodiments, the presentation modifier 420 may send an indication to the media processor 408 that the media data includes objectionable content. In some embodiments, the presentation modifier 420 may send specific information enabling the media processor 402 to modify the presentation of the media data. In some embodiments, the presentation modifier 420 may send an instruction or a command to the media processor 402 to modify the presentation of the media data.

In some embodiments, the presentation modifier 420 may modify the presentation of the media data based on the determined type of the objectionable content. For example, the presentation modifier 420 may determine that the objectionable content is included in image data (e.g., images of nudity, violence, objectionable political symbols, etc.), and modify the presentation of the image data, such as through fuzzing or blurring of the objectionable portions of the images. As another example, the presentation modifier 420 may determine that the objectionable content is included in audio data (e.g., vulgar language, screams, gun shots, explosions, etc.), and modify the audio played by the computing device, such as muting and/or playing a cover sound (e.g., a beep, static sounds, etc.) during the audio portion including the objectionable content.

In some embodiments in which media data may be stored in memory for delayed presentation, the presentation modifier 420 may send to the media processor 408 information about a specific identified portion of the media data, or a command or instruction to modify the presentation of the media data only at the specific portion of the media data. In this manner, in some embodiments, the presentation modifier 420 may limit the modifying of the presentation of the media data to the identified specific portion of the media data.

In some embodiments, the presentation modifier 420 may modify the presentation of the media data by sending an instruction to the switch 410 to prevent media data from arriving at the output device 412. As another example, the presentation modifier 420 may indicate or instruct the presentation of a critical thinking warning within a presentation of the media data. In some embodiments, the presentation modifier 420 may send to the media processor 408 and/or the output device 412 a critical thinking warning to be presented in, as a part of, before, during, after, etc. the presentation of the media data. In various embodiments, the critical thinking warning may include a visible and/or audible warning. For example, the critical thinking warning may include a notice such as “This content may include misinformation—fact checking is recommended,” or “This content may be considered controversial—viewer discretion is advised,” or “Notice: this content includes language that some may find offensive,” and/or any other suitable notification.

In some embodiments, the presentation modifier 420 may modify the presentation of the media data to prevent or minimize perceptible presentation of the objectionable content. For example, the presentation modifier 420 may indicate or instruct blurring, pixelating, defocusing, “fuzzing,” etc. of the objectionable content in an image. As another example, the presentation modifier 420 may indicate or instruct reducing the volume of or obscuring (e.g., “bleeping” over) the objectionable content in audio media data.

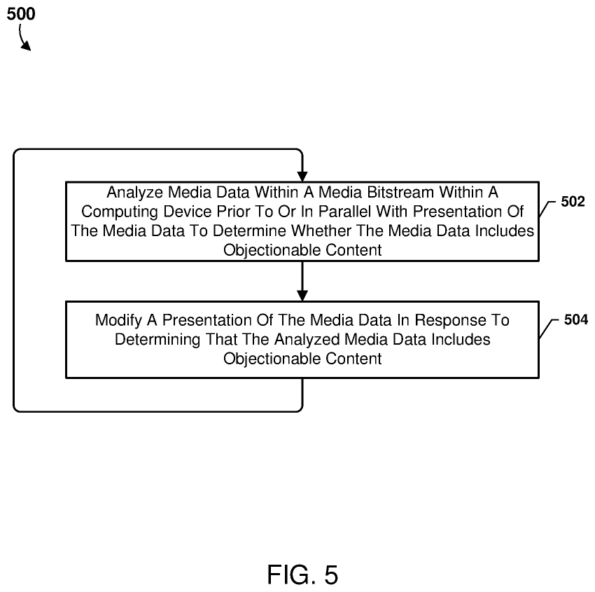

FIG. 5 is a process flow diagram illustrating a method 500 for analyzing content of a media presentation in a computing device, such as a wireless communication device 200, while receiving and presenting the media in accordance with various embodiments. With reference to FIGS. 1-5, the method 500 may be implemented by a processing device including a processor (e.g., 111, 202, 204, 312, 314, 316, 318, 360) and/or media analysis custom circuitry (e.g., 322) referred to as a processing device of a computing device (e.g., 100, 200, 400).

In block 502, the processing device may analyze the media data within a media bitstream while receiving, such as prior to or in parallel with presentation of, the media data to determine whether the media data includes objectionable content. In some embodiments, the processing device may process the media data using a machine learning model trained to recognize certain objectionable content in the media data and provide as an output a determination of whether the media data includes objectionable content, as well as a type of objectionable content in some embodiments. As part of the operations in block 502, the processing device may receive the determination of whether the media data includes objectionable content as an output from the trained machine learning model. Means for performing the operations of block 502 may include a processing device including the processor 111, 202, 204, 312, 314, 316, 318, 360, the selector 414, the objectionable content detector 416, and/or media analysis custom circuitry (e.g., 322).

In block 504, the processing device of the computing device may modify a presentation of the media data in response to determining that the analyzed media data includes objectionable content. In some embodiments, the processor may modify presentation of the media data to prevent or minimize perceptible presentation of the objectionable content. In some embodiments, the processor may modify presentation of the media data to display a critical thinking warning within a visual presentation of the media data. Means for performing the operations of block 504 may include a processing device including the processor 111, 202, 204, 312, 314, 316, 318, 360, the presentation modifier 420, the media processor 408 and/or media analysis custom circuitry (e.g., 322).

The processing device may repeat the operations of blocks 502 and 504 from time to time. In some embodiments, the processing device of the computing device may repeat the operations of blocks 502 and 504 periodically. In some embodiments, the processing device of the computing device may repeat the operations of blocks 502 and 504 randomly so as to avoid circumvention.

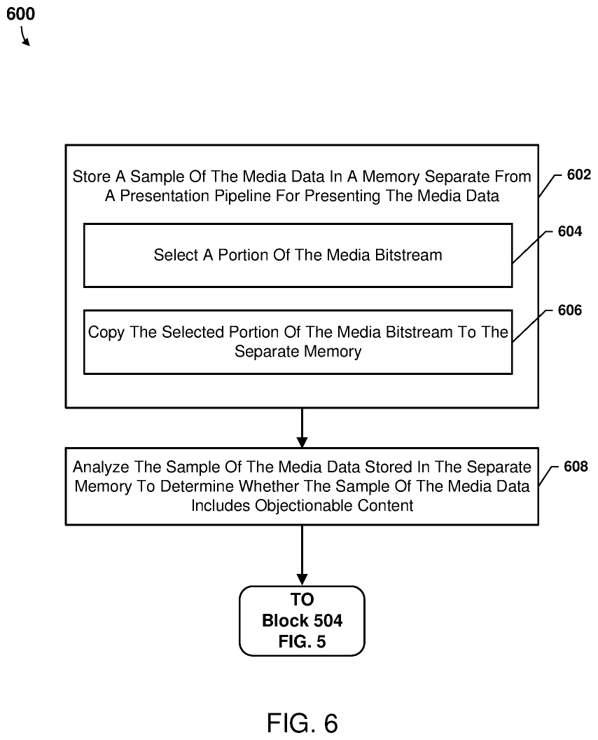

FIG. 6 is a process flow diagram illustrating operations 600 that may be performed by a computing device, such as a wireless communication device 200, as part of the method 500 for analyzing content of a media presentation in accordance with various embodiments. With reference to FIGS. 1-6, the operations 600 may be implemented by a processing device including a processor (e.g., 111, 202, 204, 312, 314, 316, 318, 360) and/or media analysis custom circuitry (e.g., 322) of a computing device (e.g., 100, 200, 400).

In block 602, the processing device may store a sample of the media data in a memory separate from a presentation pipeline for presenting the media data. For example, the processing device may store a sample of the media data in the separate memory 417 that is separate from the presentation pipeline for presenting the media data represented by blocks 404, 406, 408, and 412. Means for performing the operations of block 602 may include a processing device including the processor 111, 202, 204, 312, 314, 316, 318, 360, the selector 414, the separate memory 417, and/or media analysis custom circuitry (e.g., 322).

In some embodiments, as part of the operations of block 602, the processing device may select a portion of the media bitstream in block 604. Means for performing the operations of block 604 may include a processing device including the processor 111, 202, 204, 312, 314, 316, 318, 360, the selector 414, and/or media analysis custom circuitry (e.g., 322).

In block 606, the processing device may to the separate memory. In some embodiments, the processor may copy one or more portions of a frame of the media data in the media bitstream. Means for performing the operations of block 606 may include a processing device including the processor 111, 202, 204, 312, 314, 316, 318, 360, the selector 414, the separate memory 417, and/or media analysis custom circuitry (e.g., 322).

In block 608, the processing device may analyze the sample of the media data stored in the separate memory to determine whether the sample of the media data includes objectionable content. Means for performing the operations of block 608 may include a processing device including the processor 111, 202, 204, 312, 314, 316, 318, 360, the objectionable content detector 416, the separate memory 417, and/or media analysis custom circuitry (e.g., 322).

The processor may then modify a presentation of the media data in response to the computing device determining that the analyzed media data includes objectionable content in block 504 of the method 500 as described.

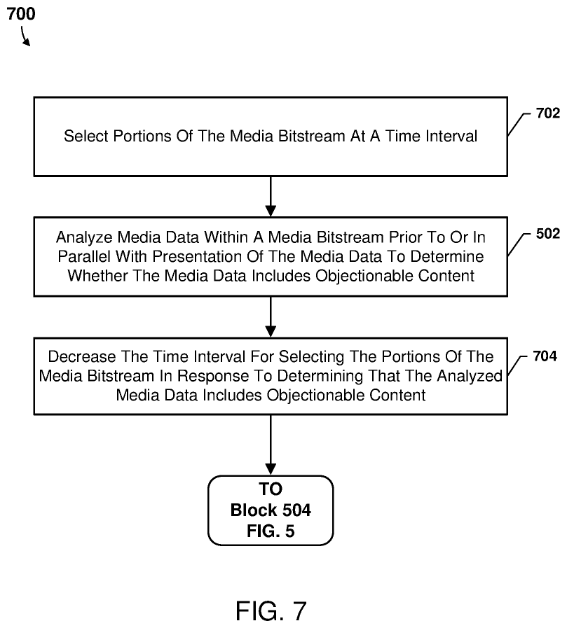

FIG. 7 is a process flow diagram illustrating operations 700 that may be performed by a computing device, such as a wireless communication device 200, as part of the method 500 for analyzing content of a media presentation in accordance with various embodiments. With reference to FIGS. 1-7, the operations 700 may be implemented by a processing device including a processor (e.g., 111, 202, 204, 312, 314, 316, 318, 360) and/or media analysis custom circuitry (e.g., 322) of a computing device (e.g., 100, 200, 400).

In block 702, the processing device may select portions of the media bitstream for analysis at a time interval or sampling frequency. In some embodiments, the processing device may select (and copy) portions of the media bitstream at an interval that is longer than (i.e., less frequent than) a frame rate of the media bitstream. For example, the processing device may select portion(s) of the media bitstream at an initial time interval or sampling frequency (e.g., a time interval greater than a frame rate of the media bitstream). In some embodiments, the time interval may be an initial time interval (i.e., at an initial sampling frequency). Means for performing the operations of block 608 may include a processing device including the processor 111, 202, 204, 312, 314, 316, 318, 360, the selector 414 and/or media analysis custom circuitry (e.g., 322).

In block 704, the processing device may analyze media data within selected portions of the media bitstream while receiving, such as prior to or in parallel with presentation of, the media data to determine whether the media data includes objectionable content as described. The analysis of media data within the selected portions of the media bitstream may be performed consistent with the operations in block 502 of the method 500 as described. The analysis operations in in block 704 may be performed at the sampling frequency.

In block 706, the processing device may adjust when portions of the media bitstream may be sampled for analysis in response to determining that the analyzed media data includes objectionable content. In particular, the processing device may decrease the time interval or increase the sampling frequency for selecting the portions of the media bitstream in response to determining that the analyzed media data includes objectionable content. In some embodiments, the objectionable content detector 416 may adjust the time interval at which the selector 414 and/or media analysis custom circuitry selects and/or copies the portions of the media bitstream. In some embodiments, in response to determining that the analyzed media data includes objectionable content, the objectionable content detector 416 within a processing device may send an indication or instruction in operation 425 to decrease the time interval or increase the sampling frequency for selecting portions of the media bitstream for analysis. In some embodiments, in response to the instruction or indication to decrease the time interval, the selector 414 within a processing device may select and/or copy the portions of the media bitstream more frequently (i.e., using a smaller time interval). In some embodiments the processing device may sample portions of the media bitstream at random intervals to prevent or reduce circumvention of the protections against presenting objectionable material. In this manner, the processing device may dynamically adjust the frequency at which portions of the media bitstream are selected for analysis. Means for performing the operations of block 608 may include a processing device including the processor 111, 202, 204, 312, 314, 316, 318, 360, the objectionable content detector 416, the selector 414 and/or media analysis custom circuitry (e.g., 322).

The processing device may then modify a presentation of the media data in response to the processing device determining that the analyzed media data includes objectionable content in block 504 of the method 500 as described.

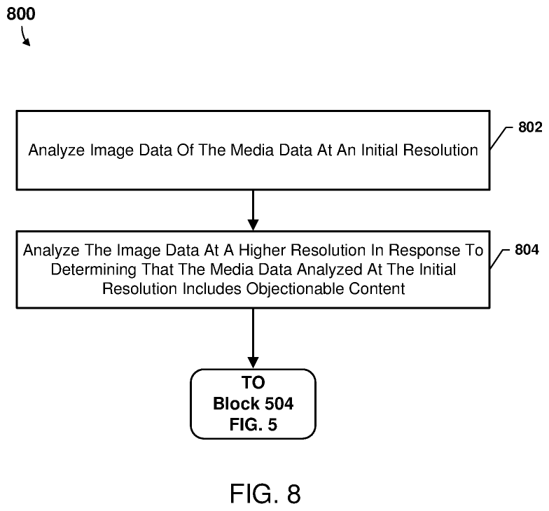

FIG. 8 is a process flow diagram illustrating operations 800 that may be performed by a computing device, such as a wireless communication device 200, as part of the method 500 for analyzing content of a media presentation in accordance with various embodiments. With reference to FIGS. 1-8, the operations 800 may be implemented by a processing device including a processor (e.g., 111, 202, 204, 312, 314, 316, 318, 360) and/or media analysis custom circuitry (e.g., 322) of a computing device (e.g., 100, 200, 400).

In block 802, the processing device may analyze image data of the media data at an initial resolution. Means for performing the operations of block 802 may include a processing device including the processor 111, 202, 204, 312, 314, 316, 318, 360, the objectionable content detector 416 and/or media analysis custom circuitry (e.g., 322).

In block 802, the processing device may analyze the image data at a higher resolution in response to determining that the media data analyzed at the initial resolution includes objectionable content. Means for performing the operations of block 804 may include a processing device including the processor 111, 202, 204, 312, 314, 316, 318, 360, the objectionable content detector 416 and/or media analysis custom circuitry (e.g., 322). In this manner, the processor may conserve processing resources by performing an initial analysis at a relatively low resolution, and then in response to making an initial determination of that the media data includes objectionable content, analyze the image data at a higher resolution.

The processing device may then modify a presentation of the media data in response to the computing device determining that the analyzed media data includes objectionable content in block 504 as described.

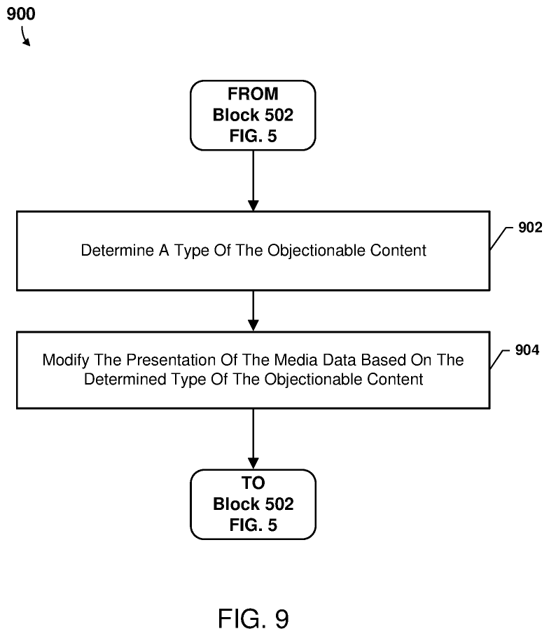

FIG. 9 is a process flow diagram illustrating operations 900 that may be performed by a computing device, such as a wireless communication device 200, as part of the method 500 for analyzing content of a media presentation in accordance with various embodiments. With reference to FIGS. 1-9, the operations 900 may be implemented by a processing device including a processor (e.g., 111, 202, 204, 312, 314, 316, 318, 360) and/or media analysis custom circuitry (e.g., 322) of a computing device (e.g., 100, 200, 400).

After performing the analysis of media data within a media bitstream while receiving, such as prior to or in parallel with presentation of, the media data to determine whether the media data includes objectionable content in block 502 as described, the processing device may determine a type of the objectionable content in block 902. For example, the processing device may determine that the type of objectionable content is pornography or sexual content, foul language, misinformation, disinformation, propaganda, content that is not suitable for children under a specified age, and or the like. Means for performing the operations of block 902 may include a processing device including the processor 111, 202, 204, 312, 314, 316, 318, 360, the objectionable content type detector 418, and/or media analysis custom circuitry (e.g., 322).

In block 904, the processing device may modify the presentation of the media data based on the determined type of the objectionable content. For example, the processing device may block or obfuscate a presentation of content determined to be a type of pornography or sexual content. As another example, the processing device may present a critical thinking warning for a type of objectionable content including misinformation, disinformation, or propaganda. Means for performing the operations of block 902 may include a processing device including the processor 111, 202, 204, 312, 314, 316, 318, 360, the presentation modifier 420, and/or media analysis custom circuitry (e.g., 322).

The processing device may again analyze media data within a media bitstream while receiving, such as prior to or in parallel with presentation of, the media data to determine whether the media data includes objectionable content in block 502 as described.

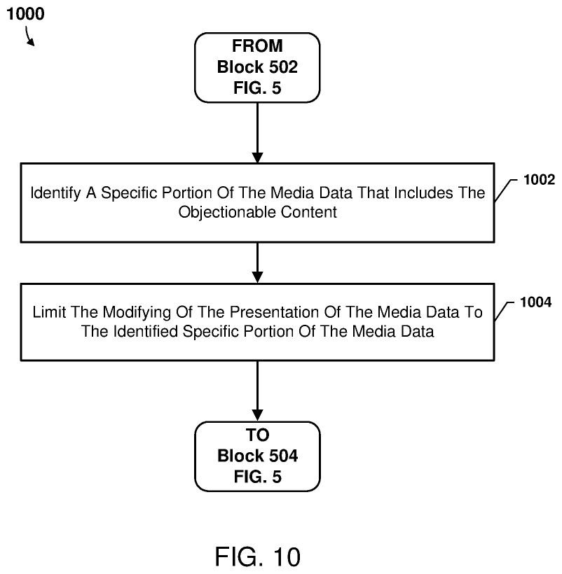

FIG. 10 is a process flow diagram illustrating operations 1000 that may be performed by a computing device, such as a wireless communication device 200, as part of the method 500 for analyzing content of a media presentation in accordance with various embodiments. With reference to FIGS. 1-10, the operations 1000 may be implemented by a processing device including a processor (e.g., 111, 202, 204, 312, 314, 316, 318, 360) and/or media analysis custom circuitry (e.g., 322) of a computing device (e.g., 100, 200, 400).

After performing the analysis of media data within a media bitstream while receiving, such as prior to or in parallel with presentation of, the media data to determine whether the media data includes objectionable content in block 502 as described, the processing device may identify a specific portion of the media data or the media bitstream that includes the objectionable content in block 1002. For example, the processing device may identify objectionable content in a specific portion, location, time period, or another specific aspect of the media data or the media bitstream. As another example, the processing device may identify a specific timestamp or time range as including the objectionable content. Means for performing the operations of block 1002 may include a processing device including the processor 111, 202, 204, 312, 314, 316, 318, 360, the objectionable content detector 416, and/or media analysis custom circuitry (e.g., 322).

In block 1004, the processing device may limit the modifying of the presentation of the media data to the identified specific portion of the media data or the media bitstream. For example, the processing device may modify the presentation of the media data or the media bitstream only in a frame, in a portion of a frame, a pixel or group of pixels, or other specified or discrete location within the media data. In this manner, the processing device may limit the modifying of the presentation of the media data to the identified specific portion of the media data or the media bitstream. Means for performing the operations of block 1002 may include a processing device including the processor 111, 202, 204, 312, 314, 316, 318, 360, the presentation modifier 420, and/or media analysis custom circuitry (e.g., 322).

In block 504, the processing device may modify a presentation of the media data in response to determining in the computing device that the analyzed media data includes objectionable content as described.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 500-1000 may be substituted for or combined with one or more operations of the methods 500-1000.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method performed by a computing device for analyzing content of a media presentation, including: analyzing in the computing device media data within a media bitstream while receiving the media data to determine whether the media data includes objectionable content; and modifying a presentation of the media data by the computing device in response to determining that the analyzed media data includes objectionable content.

Example 2. The method of example 1, in which analyzing media data within a media bitstream while receiving the media data includes: processing the media data using a machine learning model trained to recognize certain objectionable content; and receiving a determination of whether the media data includes objectionable content as an output from the trained machine learning model.

Example 3. The method of any of examples 1-2, further including storing a sample of the media data in a memory separate from a presentation pipeline for presenting the media data as the media data is received by the presentation pipeline, in which analyzing media data within a media bitstream while receiving the media data includes analyzing the sample of the media data stored in the separate memory.

Example 4. The method of example 3, in which storing the sample of the media bitstream in a memory separate from the presentation pipeline for presenting the media data includes copying one or more portions of a frame of the media data in the media bitstream to the memory.

Example 5. The method of any of examples 1-4, in which analyzing media data within a media bitstream while receiving the media data includes selecting portions of the media bitstream at random time intervals; and analyzing each selected portion of the media bitstream to determine whether the selected portion of the media bitstream includes objectionable content.

Example 6. The method of any of examples 1-4, in which analyzing media data within a media bitstream while receiving the media data includes: selecting portions of the media bitstream at a time interval; analyzing each selected portion of the media bitstream to determine whether the selected portion of the media bitstream includes objectionable content; and decreasing the time interval for selecting portions of the media bitstream in response to determining that the analyzed selected portion of the media bitstream includes objectionable content.

Example 7. The method of example 6, in which the time interval includes an initial time interval that is longer than a frame rate of the media bitstream.

Example 8. The method of any of examples 1-7, in which: analyzing media data within a media bitstream while receiving the media data to determine whether the media data includes objectionable content includes analyzing image data of the media data at an initial resolution; and the method further includes analyzing the image data at a higher resolution in response to determining that the media data analyzed at the initial resolution includes objectionable content.

Example 9. The method of any of examples 1-8, in which: analyzing media data within a media bitstream while receiving the media data to determine whether the media data includes objectionable content includes determining a type of the objectionable content; and modifying a presentation of the media data in response to determining that the analyzed media data includes objectionable content includes modifying the presentation of the media data based on the determined type of the objectionable content.

Example 10. The method of any of examples 1-9, in which: analyzing media data within a media bitstream while receiving the media data to determine whether the media data includes objectionable content includes identifying a specific portion of the media data that includes the objectionable content; and modifying a presentation of the media data in response to determining that the analyzed media data includes objectionable content includes limiting the modifying of the presentation of the media data to the identified specific portion of the media data.

Example 11. The method of any of examples 1-10, in which modifying presentation of the media data includes modifying presentation of the media data to prevent or minimize perceptible presentation of the objectionable content.

Example 12. The method of any of examples 1-11, in which modifying presentation of the media data includes modifying presentation of the media data to presenting a critical thinking warning within a presentation of the media data.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process may be stored in memory so the process may seamlessly resume its operations when it returns to execution on the processor. This operation state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavyweight process that includes multiple lightweight processes or threads, which are processes that share all or portions of their context (e.g., address space, stack, permissions, and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the spirit or scope of the embodiments. Thus, various embodiments are not intended to be limited to the embodiments shown herein but are to be accorded the widest scope consistent with the following claims and the principles and novel features disclosed herein.

1. A method performed by a computing device for analyzing content of a media presentation, comprising:
analyzing, in the computing device, media data within a media bitstream while receiving the media data to determine whether the media data includes objectionable content, comprising:
selecting, at a random time interval, decoded portions of the media bitstream stored in a frame buffer that is part of a presentation pipeline of the computing device; and
analyzing the selected decoded portions of the media bitstream separate from the presentation pipeline to determine whether the selected portion of the media bitstream includes objectionable content; and
modifying a presentation of the media data that has been sent from the frame buffer to a media processor that is part of the presentation pipeline of the computing device to be prepared for output by an output device in response to determining that the analyzed media data includes objectionable content.

2. The method of claim 1, wherein analyzing the media data within the media bitstream while receiving of the media data comprises:
processing the media data using a machine learning model trained to recognize objectionable content; and
receiving a determination of whether the media data includes objectionable content as an output from the trained machine learning model.

3. The method of claim 1, further comprising storing a sample of the media data in a memory separate from the presentation pipeline for presenting the media data as the media data is received by the presentation pipeline, wherein analyzing the media data within the media bitstream while receiving the media data comprises analyzing the sample of the media data stored in the separate memory.

4. The method of claim 3, wherein storing the sample of the media bitstream in a memory separate from the presentation pipeline for presenting the media data comprises copying one or more portions of a frame of the media data in the media bitstream to the memory.

5. (canceled)

6. The method of claim 1, wherein analyzing the media data within the media bitstream while receiving the media data comprises:
decreasing the random time interval to a decreased time interval in response to determining that the analyzed selected portion of the media bitstream includes objectionable content; and
selecting, at the decreased time interval, second decoded portions of the media bitstream stored in the frame buffer that is part of the presentation pipeline of the computing device.

7. The method of claim 6, wherein the random time interval is longer than a frame rate of the media bitstream.

8. The method of claim 1, wherein:
analyzing the media data within the media bitstream while receiving the media data to determine whether the media data includes objectionable content comprises analyzing image data of the media data at an initial resolution; and
the method further comprises analyzing the image data at a higher resolution in response to determining that the media data analyzed at the initial resolution includes objectionable content.

9. The method of claim 1, wherein:
analyzing media data within the media bitstream while receiving the media data to determine whether the media data includes objectionable content comprises determining a type of the objectionable content; and
modifying the presentation of the media data in response to determining that the analyzed media data includes objectionable content comprises modifying the presentation of the media data based on the determined type of the objectionable content.

10. The method of claim 1, wherein:
analyzing media data within the media bitstream while receiving the media data to determine whether the media data includes objectionable content comprises identifying a specific portion of the media data that includes the objectionable content; and
modifying the presentation of the media data in response to determining that the analyzed media data includes objectionable content comprises limiting the modifying of the presentation of the media data to the identified specific portion of the media data.

11. The method of claim 1, wherein modifying the presentation of the media data comprises modifying the presentation of the media data to prevent or minimize perceptible presentation of the objectionable content.

12. The method of claim 1, wherein modifying the presentation of the media data comprises modifying the presentation of the media data to present a critical thinking warning within the presentation of the media data.

13. A computing device, comprising:
a memory separate from a presentation pipeline for presenting media data; and
a processing device coupled to the memory and configured to:
analyze, in the computing device, media data within a media bitstream while receiving the media data to determine whether the media data includes objectionable content, wherein to analyze the media data, the processing device is configured to:
select, at a random time interval, decoded portions of the media bitstream stored in a frame buffer that is part of a presentation pipeline of the computing device; and
analyze the selected decoded portions of the media bitstream separate from the presentation pipeline to determine whether the selected portion of the media bitstream includes objectionable content; and
modify a presentation of the media data that has been sent from the frame buffer to a media processor that is part of the presentation pipeline of the computing device to be prepared for output by an output device in response to determining that the analyzed media data includes objectionable content.

14. The computing device of claim 13, wherein the processing device is further configured to:
process the media data using a machine learning model trained to recognize certain objectionable content; and
receive a determination of whether the media data includes objectionable content as an output from the trained machine learning model.

15. The computing device of claim 13, wherein the processing device is further configured to store a sample of the media data in a memory separate from the presentation pipeline for presenting the media data as the media data is received by the presentation pipeline, and analyze media data within the media bitstream while receiving the media data by analyzing the sample of the media data stored in the separate memory.

16. The computing device of claim 15, wherein the processing device is further configured to store a sample of the media data in a memory separate from the presentation pipeline for presenting the media data as the media data is received by the presentation pipeline by copying one or more portions of a frame of the media data in the media bitstream to the memory.

17. (canceled)

18. The computing device of claim 13, wherein the processing device is further configured to:
decrease the random time interval to a decreased time interval in response to determining that the analyzed selected portion of the media bitstream includes objectionable content; and
selecting, at the decreased time interval, second decoded portions of the media bitstream stored in the frame buffer that is part of the presentation pipeline of the computing device.

19. The computing device of claim 13, wherein the processing device is further configured to:
analyze image data of the media data at an initial resolution; and
analyze the image data at a higher resolution in response to determining that the media data analyzed at the initial resolution includes objectionable content.

20. The computing device of claim 13, wherein the processing device is further configured to:
determine a type of the objectionable content; and
modify the presentation of the media data based on the determined type of the objectionable content.

21. The computing device of claim 13, wherein the processing device is further configured to:
identify a specific portion of the media data that includes the objectionable content; and
limit modification of the presentation of the media data to the identified specific portion of the media data.

22. The computing device of claim 13, wherein the processing device is further configured to modify the presentation of the media data to prevent or minimize perceptible presentation of the objectionable content.

23. The computing device of claim 13, wherein the processing device is further configured to present a critical thinking warning within the presentation of the media data.

24. The computing device of claim 13, further comprising a wireless transceiver coupled to the processing device, wherein the computing device is a wireless communication device.

25. A computing device, comprising:
means for analyzing in the computing device media data within a media bitstream while receiving the media data to determine whether the media data includes objectionable content, comprising:
means for selecting, at a random time interval, decoded portions of the media bitstream stored in a frame buffer that is part of a presentation pipeline of the computing device; and
means for analyzing the selected decoded portions of the media bitstream separate from the presentation pipeline to determine whether the selected portion of the media bitstream includes objectionable content; and
means for modifying a presentation of the media data that has been sent from the frame buffer to a media processor that is part of the presentation pipeline of the computing device to be prepared for output by an output device in response to determining that the analyzed media data includes objectionable content.

26. The computing device of claim 25, wherein means for analyzing the media data within the media bitstream while receiving of the media data comprises:
means for processing the media data using a machine learning model trained to recognize objectionable content; and
means for receiving a determination of whether the media data includes objectionable content as an output from the trained machine learning model.

27. The computing device of claim 25, further comprising means for storing a sample of the media data in a memory separate from the presentation pipeline for presenting the media data as the media data is received by the presentation pipeline,
wherein means for analyzing the media data within the media bitstream while receiving the media data comprises means for analyzing the sample of the media data stored in the separate memory.

28. (canceled)

29. The computing device of claim 25, wherein means for analyzing the media data within the media bitstream while receiving the media data comprises:
means for decreasing the random time interval to a decreased time interval in response to determining that the analyzed selected portion of the media bitstream includes objectionable content; and
means for selecting, at the decreased time interval, second decoded portions of the media bitstream stored in the frame buffer that is part of the presentation pipeline of the computing device.

30. A non-transitory processor-readable medium having stored thereon processor-executable instructions configured to cause a processor of a computing device to perform operations comprising:
analyzing media data within a media bitstream while receiving, such as prior to or in parallel with presentation of, the media data to determine whether the media data includes objectionable content, comprising:
selecting, at a random time interval, decoded portions of the media bitstream stored in a frame buffer that is part of a presentation pipeline of the computing device; and
analyzing the selected decoded portions of the media bitstream separate from the presentation pipeline to determine whether the selected portion of the media bitstream includes objectionable content; and
modifying a presentation of the media data that has been sent from the frame buffer to a media processor that is part of the presentation pipeline of the computing device to be prepared for output by an output device in response to determining that the analyzed media data includes objectionable content.
